(19) United States
(12) Patent Application Publication
(10) Pub. No.: US 2009/0110196 A1
(43) Pub. Date: Apr. 30, 2009

(54) Key management system and method for wireless networks

(75) Inventors: Frank Chee-Da Tsai, Taipei City (TW); Yi-Chung Shen, Kaohsiung City (TW); Jian-Chian Chiou, Taipei County (TW); Hung-Min Sun, Taichung City (TW); Shuai-Min Chen, Taipei County (TW); Yue-Hsun Lin, Chiayi County (TW); Ying-Chu Hsiao, Taichung County (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 12/076,930

(22) Filed: Mar. 25, 2008

(30) Foreign Application Priority Data
Oct. 29, 2007 (TW) 96140574

(51) Int. Cl. H04L 9/32; H04L 9/30; H04L 9/14; H04L 9/08

(52) U.S. Cl. 380/258; 726/3; 380/277; 380/281

(57) ABSTRACT

A key management method for wireless networks is disclosed. Before a mobile station residing in a first ASN switches to a neighboring second ASN, an authentication process between the mobile station and the second ASN is implemented. Thus, the authentication process is not required when the mobile station is switching to the second ASN.

### BACKGROUND OF THE INVENTION

1. Field of the Invention

The invention relates to data processing for a wireless network, and more particularly to a key management system and method for wireless networks.

2. Description of the Related Art

FIG. 1 is a schematic view of a network structure for a WiMAX standard. The WiMAX network structure comprises two operators, a network access provider (NAP) and a network service provider (NSP). With respect to the WiMAX standard, the NAP provides WiMAX wireless access services using one or more access service networks (ASN). The NAP provides complete functions for a mobile station (MS). With respective to authentication, authorization, and accounting (AAA) infrastructure, the NAP relays AAA messages to an AAA server residing in the backend of the NSP.

Additionally, the NSP acts as the main service provider, composed of one or more connectivity service network (CSN). Since authentication is provided by the NSP, the AAA server usually resides in the CSN. Based on such structure, the ASN can be an AAA proxy server or an AAA authenticator. Generally, the ASN usually acts as a message forwarder for communication and each ASN comprises one or more base stations (BS). Each base station provides large wireless access scope and communication mechanisms.

The WiMAX network system applies extensible authentication protocol (EAP) during authentication, wherein the EAP comprises EAP-Transport Level Security (EAP-TLS), EAP-Authentication and Key Agreement Protocol (EAP-AKA), EAP-Subscriber Identity Module (EAP-SIM), . . . and so on. The EAP-TLS utilizes the public key infrastructure (PKI), which provides high security. The WiMAX standard supports mobility, defining micro handoff and macro handoff. The “micro handoff” indicates that a mobile station has wandered from an emitting range of a base station to that of another base station, whereby both the base stations reside in the same ASN. The “macro handoff” indicates that a mobile station has wandered from an ASN to another ASN, whereby the mobile station is authenticated since gateways of both the ASNs reside in the same CSN range.

When the “macro handoff” is implemented, a mobile station must be authenticated using the EAP mechanism, which is safer but more complicated for authentication switch operations. Thus, if there is no optimization mechanism when switch operations are required, the authentication process is time-consuming and connections may be interrupted when seamless handoff for the mobile station is performed.

Thus, the invention provides a key management system and method for wireless networks, providing a safe and fast re-connection protocol.

### BRIEF SUMMARY OF THE INVENTION

Key management methods for wireless networks are provided. An exemplary embodiment of a key management method for wireless networks comprises the following.

Before a mobile station, residing in a first access service network (ASN), switches to a neighboring second ASN, an authentication process between the mobile station and the second ASN is pre-implemented, such that the authentication process is not required when the mobile station is switching to the second ASN.

Key management systems for wireless networks are provided. An exemplary embodiment of a key management system for wireless networks comprises a mobile station, a first ASN comprising the mobile station, and a second ASN. Before the mobile station residing in the first ASN switches to a neighboring second ASN, an authentication process between the mobile station and the second ASN is pre-implemented, such that the authentication process is not required when the mobile station is switching to the second ASN.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a network structure for a WiMAX standard;

FIGS. 2A and 2B are flowcharts of a key management method for wireless networks of the present invention; and

FIG. 3 is a schematic view of a key management system for wireless networks of the present invention.

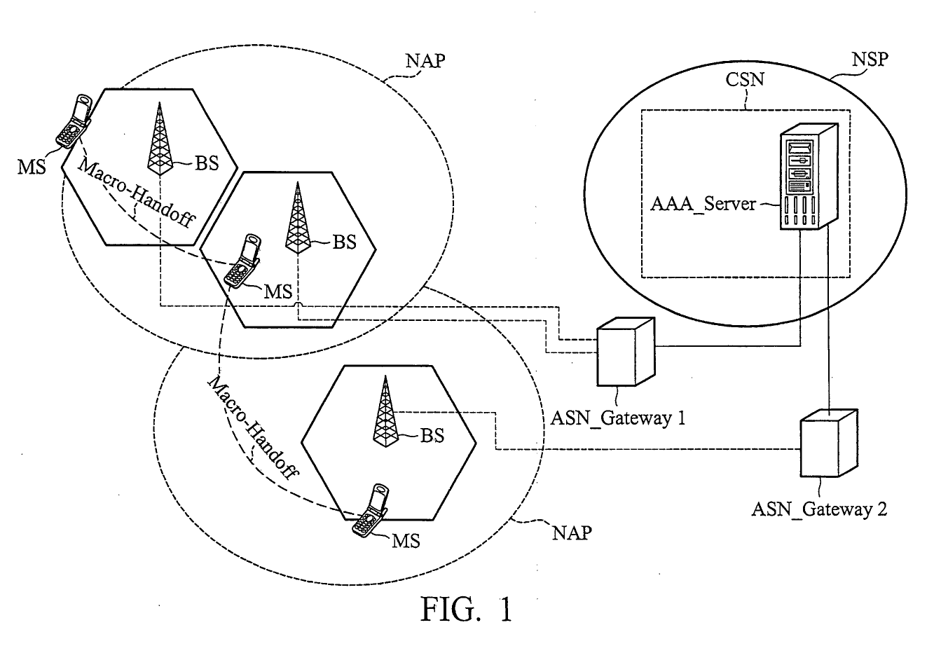

### DETAILED DESCRIPTION OF THE INVENTION

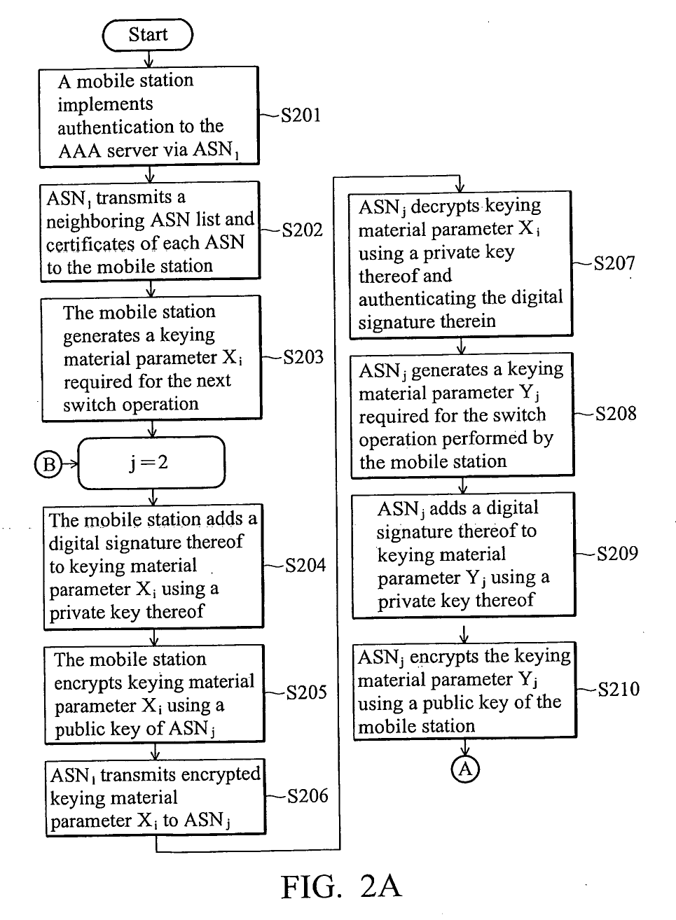

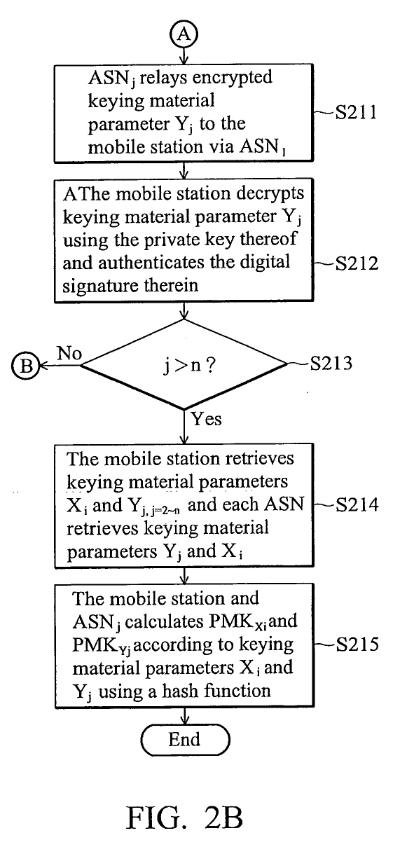

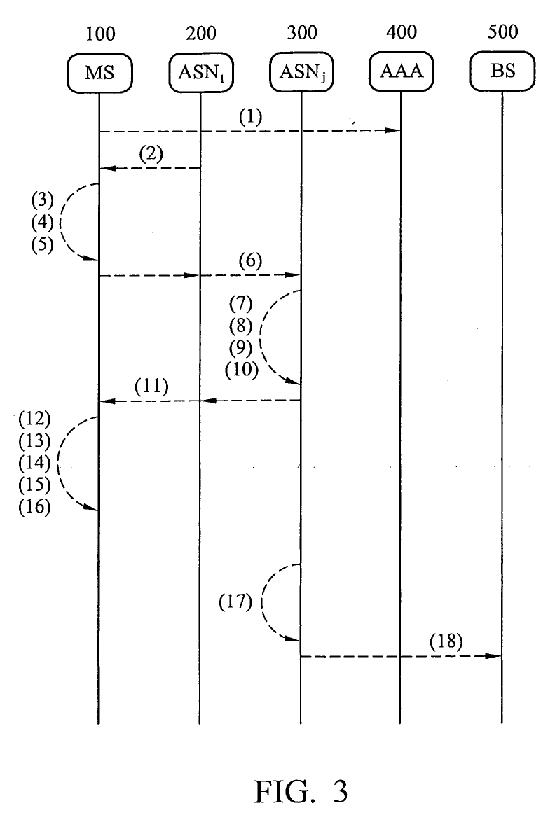

Several exemplary embodiments of the invention are described with reference to FIGS. 2 through 3, which generally relate to key management for wireless networks. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a key management system and method for wireless networks.

An embodiment of a key management system and method for wireless networks pre-calculates pairwise master keys (generating keying material parameters for the pairwise master keys) for subsequent switched ASNs before actual switching occurs. The keying material parameter is, but is not limited to, a pseudo-random number. Thus, when the mobile station switches to one of the ASNs, required pairwise master keys can be calculated fast according to the pre-calculated keying material parameters and public and private keys for subsequent switches can be accordingly calculated.

FIGS. 2A and 2B are flowcharts of a key management method for wireless networks of the present invention.

A mobile station resides in the scope of ASN₁ mutually implementing authentication to the AAA server therebetween using the EAP-TLS protocol and Remote Authentication Dial-in User Service (RADIUS) (step S201). In this step, ASN₁ and the AAA server are accountable to the mobile station. ASN₁ transmits a neighboring ASN list (NL) (ASNⱼ, j=2˜n) and certificates of each ASN to the mobile station (step S202). The neighboring ASN list comprises an identity (ID) of each ASN and a certificate of each ASN comprises the public key thereof. Each ASN ID of the ASN list mutually corresponds to the ASN certificates of the NCL, represented by (ASN₁, PUK_ASN₁), (ASN₂, PUK_ASN₂), (ASNₙ, PUK_ASNₙ). In this embodiment, suppose the number of ASNs neighboring to ASN₁ is less than 10, than the data amount to be received by the mobile station would be acceptable. Certificates of each ASN is issued by a root certificate authority (CA) and the mobile station can verify the certificate of the i-th ASN (PUK_ASNᵢ) using certificates of the root certificate authority.

The mobile station generates a keying material parameter Xᵢ required for the next switch operation (step S203). Since the mobile station only connects to ASN₁, the keying material parameter Xᵢ must be relayed to ASN₂, ASN₃, . . . , ASNᵢ via ASN₁. Before the keying material parameter Xᵢ is relayed to ASNⱼ, the mobile station adds a digital signature thereof to the keying material parameter Xᵢ using a private key thereof (PRI_MS, j=2) (step S204), encrypts the keying material parameter Xᵢ using a public key of ASN₂ (PUK_ASN₂), and adds the ID of ASN₂ to the keying material parameter Xᵢ (step S205). The encrypted keying material parameter Xᵢ can be represented as ENCPUK_ASN₂(SIGPRI_MS(Xᵢ))∥MS-ID∥ASN₂-ID, which is only an example and is not to be limitative.

ASN₁ transmits the keying material parameter Xᵢ encrypted by the mobile station to ASN₂ based on the ID of ASN₂ (step S206). When the keying material parameter Xᵢ is received, ASN₂ decrypts the keying material parameter Xᵢ using a private key thereof and authenticates the digital signature therein (step S207). If the authentication is correct, the keying material parameter Xᵢ is not altered during the relay and is generated by the mobile station. ASN₂ generates a keying material parameter Y₂ required for the switch operation performed by the mobile station (step S208), adds a digital signature thereof to the keying material parameter Y₂ using a private key thereof (RPI_ASN₂) (step S209), and encrypts the keying material parameter Y₂ using a public key (PUK_MS) of the mobile station (step S210). The encrypted second keying material parameter Y₂ is represented by ENCPUK_MS(SIGPRI_ASN₂(Y₂))∥MS-ID∥ASN₂-ID.

ASN₂ relays the encrypted keying material parameter Y₂ to the mobile station via ASN₁ (step S211). ANS₁ can relay one or more received keying material parameters to the mobile station. When the keying material parameter Y₂ is received via ASN₁, the mobile station decrypts the keying material parameter Y₂ using the private key thereof and authenticates the digital signature therein (step S212). When the authentication between the mobile station and ASN₂ (j=2) is complete, it is determined whether j>n (step S213), and, if so, steps S204˜S212 are repeated until j>n.

When the authentications between the mobile station and all the ASNs are complete, the mobile station retrieves a self-generated keying material parameter Xᵢ and a keying material parameter Y_{j, j=}2˜n from ASN_{j, j=}2˜n and each ASN retrieves the self-generated keying material parameter Yⱼ and the keying material parameter Xᵢ from the mobile station (step S214). When the mobile station switches to ASNⱼ, the mobile station and ASNⱼ calculates PMK_{Xi} and PMK_{Yj} according to the keying material parameters Xᵢ and Yⱼ while using a hash function (step S215). If PMK_{Xi} equals to PMK_{Yj}, an authentication key (AK) corresponding to 802.16 standards can be calculated. ASNⱼ relays the authentication key to a running base station, such that the mobile station can switch to ASNⱼ.

It is noted that pairwise master keys can be pre-calculated or calculated when a switch operation is preformed. Additionally, pairwise master keys can be calculated using a hash function, represented by PMKᵢ(PMKᵢ=H(Xᵢ∥Yⱼ)).

FIG. 3 is a schematic view of a key management system for wireless networks of the present invention.

An embodiment of a key management system for wireless networks at least comprises a mobile station (MS) 100, a first ASN (ASN₁), a second ASN (ASN₂), an AAA server 400, and a base station (BS) 500. The base station 100 resides in the first ASN 200.

The mobile station 100 mutually implements authentication to the AAA server 400 therebetween using the EAP-TLS protocol and Remote Authentication Dial-in User Service (RADIUS), as represented by operation (1). The first ASN 200 transmits a neighboring ASN list (NL) and certificates of each ASN to the mobile station 100, as represented by the operation (2). The mobile station 100 generates a keying material parameter Xᵢ required for the next switch operation, as represented by the operation (3). Before the keying material parameter Xᵢ is relayed to the second ASN 300, the mobile station 100 adds a digital signature thereof to the keying material parameter Xᵢ using a private key thereof (PRI_MS) (as represented by the operation (4)), encrypts the keying material parameter Xᵢ using a public key of the second ASN 300 (PUK_ASN₂), and adds the ID of the second ASN 300 to the keying material parameter Xᵢ, as represented by the operation (5). The first ASN 200 transmits the keying material parameter Xᵢ encrypted by the mobile station 100 to the second ASN 200 based on the ID of the second ASN 200, as represented by the operation (6).

When the keying material parameter Xᵢ is received, the second ASN 300 decrypts the keying material parameter Xᵢ using a private key thereof and authenticates the digital signature therein, as represented by the operation (7). The second ASN 300 generates a keying material parameter Y₂ required for the switch operation performed by the mobile station 100 (as represented by the operation (8)), adds a digital signature thereof to the keying material parameter Y₂ using a private key thereof (RPI_ASN₂) (as represented by the operation (9)), and encrypts the keying material parameter Y₂ using a public key (PUK_MS) of the mobile station 100 (as represented by the operation (10)). The second ASN 300 relays the encrypted keying material parameter Y₂ to the mobile station 100 via the first ASN 200, as represented by the operation (11). When the keying material parameter Y₂ is received via the first ASN 200, the mobile station 100 decrypts the keying material parameter Y₂ using the private key thereof and authenticates the digital signature therein, as represented by the operation (12).

If other ASNs (ASN₃˜ASNₙ) are provided, the operations (4)˜(12) are repeated until j>n. When the authentication between the mobile station 100 and the second ASN 300 is complete, the mobile station 100 retrieves the self-generated keying material parameter Xᵢ and the keying material parameter Y₂ from the second ASN 300 and the second ASN 300 retrieves the self-generated keying material parameter Yⱼ and the keying material parameter Xᵢ from the mobile station 100, as represented by the operations (12)˜(15). When the mobile station 100 switches to the second ASN 300, the mobile station 100 and the second ASN 300 calculates PMK_{Xi} and PMK_{Yj} according to the keying material parameter Xᵢ and Yⱼ using a hash function, as represented by the operations (16) and (17). If PMK_{Xi} equals to PMK_{Yj}, an authentication key (AK) corresponding to the 802.16 standards can be calculated. The second ASN 300 relays the authentication key to the running base station 500, such that the mobile station 100 can switch to the second ASN 300.

An embodiment of a key management method and system for wireless networks is more efficient than conventional methods. The embodiment also provides safe authentication and key exchange, which are implemented so that partial authentication operations required after switching of an original EAP process between a mobile station and an ASN, comprising switch authentication operations between a server and a client and related challenges/responses, are omitted, which saves much time and calculation resources.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A key management method for wireless networks, comprising:
before a mobile station residing in a first access service network (ASN) switches to a neighboring second ASN, pre-implementing an authentication process between the mobile station and the second ASN, such that the authentication process is not required when the mobile station is switching to the second ASN.

2. The key management method for wireless networks as claimed in claim 1, further comprising:
before the mobile station switches to the second ASN, an authentication server authenticating the mobile station;
the first ASN transmitting a neighboring ASN list and certificates of each ASN to the mobile station; and
the mobile station transmitting a first keying material parameter to the second ASN via the first ASN.

3. The key management method for wireless networks as claimed in claim 2, further comprising:
after the mobile station retrieves the neighboring ASN list and the certificates of each ASN, generating the first keying material parameter required for a switch operation so that a first digital signature is added to the first keying material parameter using a private key;
the mobile station encrypting the first keying material parameter using a public key thereof; and
relaying the encrypted first keying material parameter to the second ASN via the first ASN.

4. The key management method for wireless networks as claimed in claim 2, further comprising:
the second ASN decrypting the first keying material parameter using a private key thereof and authenticating the first digital signature;
transmitting a second keying material parameter to the mobile station via the first ASN using the second ASN; and
the mobile station decrypting the second keying material parameter using the private key thereof and authenticating a second digital signature.

5. The key management method for wireless networks as claimed in claim 4, further comprising:
after the second ASN authenticates the first digital signature, the second ASN generating a second keying material parameter required for the switch operation performed by the mobile station;
adding the second digital signature to the second keying material parameter using a private key of the second ASN;
encrypting the second keying material parameter using a public key of the mobile station; and
relaying the encrypted second keying material parameter to the mobile station via the first ASN.

6. The key management method for wireless networks as claimed in claim 4, wherein the first ASN transmits the neighboring ASN list and the certificate of the second ASN to the mobile station when the authentication process between the mobile station and the second ASN is complete.

7. The key management method for wireless networks as claimed in claim 6, wherein the neighboring ASN list comprises an identity (ID) of the second ASN and the certificate of the second ASN comprises the public key of the second ASN.

8. The key management method for wireless networks as claimed in claim 7, wherein the first ASN relays the first keying material parameter encrypted by the mobile station to the second ASN according to the ID of the second ASN.

9. The key management method for wireless networks as claimed in claim 4, further comprising:
when the authentication process between the mobile station and the second ASN is complete, the mobile station and the second ASN retrieving the first and second keying material parameters respectively;
when the mobile station switches to the second ASN, the mobile station and the second ASN respectively calculating a first pairwise master key and a second pairwise master key according to the first and second keying material parameters;
the mobile station generating an authentication key thereof using the first pairwise master key and the second ASN generating an authentication key thereof using the second pairwise master key; and
the second ASN transmitting the authentication key thereof to a base station thereof, enabling the mobile station to switch to the second ASN.

10. The key management method for wireless networks as claimed in claim 9, wherein, when the first ASN neighbors with a third ASN, the authenticating and encrypting steps are repeated to enable the third ASN to retrieve and authenticate the first keying material parameter and the mobile station retrieves and authenticates a third keying material parameter generated by the third ASN.

11. The key management method for wireless networks as claimed in claim 1, wherein, when the authentication process between the mobile station and the second and third ASNs is complete, the mobile station retrieves the first, second and third keying material parameters, the second ASN retrieves the first and second keying material parameters, and the third ASN retrieves the first and third keying material parameters.

12. A key management system for wireless networks, comprising:
a mobile station;
a first ASN, comprising the mobile station; and
a second ASN,
wherein, before the mobile station residing in the first ASN switches to the second ASN neighboring to the first ASN, an authentication process between the mobile station and the second ASN is pre-implemented, such that the authentication process is not required when the mobile station is switching to the second ASN.

13. The key management system for wireless networks as claimed in claim 12, further comprising an authentication server, and before the mobile station switches to the second ASN, authenticating the mobile station, wherein the first ASN transmits a neighboring ASN list and certificates of each ASN to the mobile station, and the mobile station transmits a first keying material parameter to the second ASN via the first ASN.

14. The key management system for wireless networks as claimed in claim 13, wherein, after the mobile station retrieves the neighboring ASN list and the certificates of each ASN, the first keying material parameter required for a switch operation is generated so that a first digital signature is added to the first keying material parameter using a private key, the mobile station encrypts the first keying material parameter using a public key thereof, and the encrypted first keying material parameter is relayed to the second ASN via the first ASN.

15. The key management system for wireless networks as claimed in claim 13, wherein the second ASN decrypts the first keying material parameter using a private key thereof and authenticates the first digital signature, a second keying material parameter is transmitted to the mobile station via the first ASN using the second ASN, and the mobile station decrypts the second keying material parameter using the private key thereof and authenticates a second digital signature.

16. The key management system for wireless networks as claimed in claim 15, wherein, after the second ASN authenticates the first digital signature, the second ASN generates the second keying material parameter required for the switch operation performed by the mobile station, the second digital signature is added to the second keying material parameter using a private key of the second ASN, the second keying material parameter is encrypted using a public key of the mobile station, and the encrypted second keying material parameter is relayed to the mobile station via the first ASN.

17. The key management system for wireless networks as claimed in claim 15, wherein the first ASN transmits the neighboring ASN list and the certificate of the second ASN to the mobile station when the authentication process between the mobile station and the second ASN is complete.

18. The key management system for wireless networks as claimed in claim 17, wherein the neighboring ASN list comprises an ID of the second ASN and the certificate of the second ASN comprises the public key of the second ASN.

19. The key management system for wireless networks as claimed in claim 18, wherein the first ASN relays the first keying material parameter encrypted by the mobile station to the second ASN according to the ID of the second ASN.

20. The key management system for wireless networks as claimed in claim 15, wherein, when the authentication process between the mobile station and the second ASN is complete, the mobile station and the second ASN retrieves the first and second keying material parameters, respectively, and when the mobile station switches to the second ASN, the mobile station and the second ASN respectively calculates a first pairwise master key and a second pairwise master key according to the first and second keying material parameters, the mobile station generates an authentication key thereof using the first pairwise master key and the second ASN generates an authentication key thereof using the second pairwise master key, and the second ASN transmits the authentication key thereof to a base station thereof, enabling the mobile station to switch to the second ASN.

21. The key management system for wireless networks as claimed in claim 20, wherein, when the first ASN neighbors with a third ASN, the authenticating and encrypting steps are repeated to enable the third ASN to retrieve and authenticate the first keying material parameter and the mobile station retrieves and authenticates a third keying material parameter generated by the third ASN.

22. The key management system for wireless networks as claimed in claim 12, wherein, when the authentication process between the mobile station and the second and third ASNs is complete, the mobile station retrieves the first, second and third keying material parameters, the second ASN retrieves the first and second keying material parameters, and the third ASN retrieves the first and third keying material parameters.

23. A computer-readable storage medium storing a computer program providing a key management method for wireless networks, comprising using a computer to perform:
codes for pre-implementing an authentication process between the mobile station and the second ASN before a mobile station residing in a first ASN switches to a second ASN neighboring to the first ASN, such that the authentication process is not required when the mobile station is switching to the second ASN.

24. The computer-readable storage medium as claimed in claim 23, further comprising performing:
before the mobile station switches to the second ASN,
codes for authenticating the mobile station using an authentication server;
codes for transmitting a neighboring ASN list and certificates of each ASN to the mobile station using the first ASN; and
codes for transmitting a first keying material parameter to the second ASN via the first ASN using the mobile station.

25. The computer-readable storage medium as claimed in claim 24, further comprising performing:
after the mobile station retrieves the neighboring ASN list and the certificates of each ASN,
codes for generating the first keying material parameter required for a switch operation so that a first digital signature is added to the first keying material parameter using a private key;
codes for encrypting the first keying material parameter by the mobile station using a public key thereof; and
codes for relaying the encrypted first keying material parameter to the second ASN via the first ASN.

26. The computer-readable storage medium as claimed in claim 24, further comprising performing:
codes for decrypting the first keying material parameter using a private key thereof and authenticating the first digital signature by the second ASN;
codes for transmitting a second keying material parameter to the mobile station via the first ASN using the second ASN; and
codes for decrypting the second keying material parameter using the private key thereof and authenticating a second digital signature by the mobile station.

27. The computer-readable storage medium as claimed in claim 26, further comprising performing:
after the second ASN authenticates the first digital signature,
codes for generating the second keying material parameter required for the switch operation performed by the mobile station using the second ASN;
codes for adding the second digital signature to the second keying material parameter using a private key of the second ASN;
codes for encrypting the second keying material parameter using a public key of the mobile station; and
codes for relaying the encrypted second keying material parameter to the mobile station via the first ASN.

28. The computer-readable storage medium as claimed in claim 27, further comprising performing:
codes for transmitting the neighboring ASN list and the certificate of the second ASN to the mobile station using the first ASN when the authentication process between the mobile station and the second ASN is complete.

29. The computer-readable storage medium as claimed in claim 28, further comprising performing:
codes for relaying the first keying material parameter encrypted by the mobile station to the second ASN using the first ASN according to the ID of the second ASN.

30. The computer-readable storage medium as claimed in claim 26, further comprising performing:
codes for retrieving the first and second keying material parameters respectively using the mobile station and the second ASN when the authentication process between the mobile station and the second ASN is complete;
codes for respectively calculating a first pairwise master key and a second pairwise master key using the mobile station and the second ASN according to the first and second keying material parameters when the mobile station switches to the second ASN;
codes for generating an authentication key of the mobile station using the first pairwise master key and generating an authentication key of the second ASN using the second pairwise master key; and
codes for transmitting the authentication key of the second ASN to a base station of the second ASN, enabling the mobile station to switch to the second ASN.

31. The computer-readable storage medium as claimed in claim 30, further comprising performing:
codes for repeating the authenticating and encrypting steps, when the first ASN neighbors with a third ASN, to enable the third ASN to retrieve and authenticate the first keying material parameter and retrieving and authenticating a third keying material parameter generated by the third ASN using the mobile station.

32. The computer-readable storage medium as claimed in claim 23, further comprising performing:
codes for retrieving the first, second and third keying material parameters using the mobile station, retrieving the first and second keying material parameters using the second ASN, and retrieving the first and third keying material parameters using the third ASN when the authentication process between the mobile station and the second and third ASNs is complete.
